(19) United States
(12) Patent Application Publication
(10) Pub. No.: US 2008/0132234 A1
(43) Pub. Date: Jun. 5, 2008

(54) APPARATUS AND METHOD FOR UTILIZING THE TRANSPORT LAYER TO PROVIDE MEASUREMENT OPPORTUNITIES FOR THE PHYSICAL LAYER IN A MULTI-MODE NETWORK

(75) Inventor: Dennis W. Gilliland, St. Charles, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/565,617

(22) Filed: Nov. 30, 2006

(51) Int. Cl. H04Q 7/20

(52) U.S. Cl. 455/436; 455/444; 370/328

(57) ABSTRACT

A Mobile station (200) comprises a data application layer (215), a transport control layer (213) using TCP or UDP, a Radio Link Control layer (RLC) (211), a Medium Access Control layer (MAC) (209), and two or more radio technology Physical Layer (PHY) components, such as PHY I (203), PHY II (205) and PHY III (207). In addition, mobile station (200) has interoperation module (201). The mobile station (200) interoperation module (201) may send and receive messages between the physical layer (203), (205), (207), etc. and the transport layer (213). The mobile station may transmit and receive various messages to and from the base station on the physical layer air interface (227). The mobile station (201) interoperation module (201) enables the transport control layer (213) to create measurement opportunities for the mobile station in circumstances wherein a handover for one physical layer to another is warranted.

### FIELD OF THE DISCLOSURE

The present disclosure relates generally to multi-mode communications networks wherein various radio technologies are employed at the physical layer, and wherein Internet Protocol/Transport Control Protocol is used at the transport layer, and more particularly to methods and apparatuses for enabling a mobile station to perform measurements prior to handing over between the various radio technologies.

### BACKGROUND

Wireless communications systems wherein a single radio technology (or physical layer technology with respect to the OSI Seven Layer Reference Model) is used generally support handover of a mobile station from one base station coverage area to another.

Coverage areas may be determined or defined in various ways such as, but not limited to, radio coverage areas as determined by a base station antenna beam width, allocated channels corresponding to such antenna beam widths, levels of radio signal strength perceived at the mobile station, channel congestion at a specific point in time, or any other appropriate criteria. Regardless of the specifics of the defined coverage areas, a mobile station in general must measure parameters of one or more candidate coverage areas when handover is needed due to some parameter of the serving coverage area failing to meet a threshold, for example.

Therefore, various radio technologies have provisions for a mobile station to make the necessary measurements, without being disruptive to ongoing communications such as an in-progress file transfer. For example, UMTS provides a compressed mode wherein transmission gaps are created in the mobile station's data transmission sequence. These gaps in time may then be used as intervals in which the mobile station may make the necessary measurements, of a neighboring base station radio signal for example.

Unfortunately, not all radio technologies employ this approach and therefore, in a multi-mode network environment, a mobile station may not have the needed measurement opportunity when attempting to handover between different radio technologies.

Thus, there is a need for a method and apparatus to provide a mobile station, handing over from a first radio technology to a second different radio technology, with an opportunity to make measurements of the candidate channels of the second different radio technology.

### BRIEF DESCRIPTION OF THE DRAWINGS

FIG. 1 is a block diagram of network wherein a mobile station may communicate using various radio access technologies and using a packet transport protocol such as TCP.

FIG. 2 is block diagram of a mobile station and base station architecture in accordance with an embodiment.

FIG. 3 is diagram showing a mobile station in accordance with an embodiment.

FIG. 4 is a flow chart showing operation of a mobile station in accordance with various embodiments.

FIG. 5 is a flow chart showing operation of a mobile station in accordance with various embodiments.

### DETAILED DESCRIPTION

In accordance with the embodiments, a mobile station may use Layer 4, the transport layer of the mobile station protocol stack, and specifically TCP/UDP to determine when receive data from a first physical layer communication is not expected. Further, in some embodiments the transport layer may be used to create opportunities to allow the mobile station physical layer to perform needed neighbor measurements.

The embodiments makes use of TCP acknowledgement scheduling techniques to create holes in the expected receive data stream. The created holes are thus measurement opportunities for situation wherein the signal conditions of a current radio link reach a level where a handover may be required. Thus the various embodiments use higher layers of a mobile station protocol stack to either determine the existence of, or create, an opportunity for the mobile station physical layer to perform alternate work, for example, the work of measuring signal strength on neighboring Radio Access Technologies.

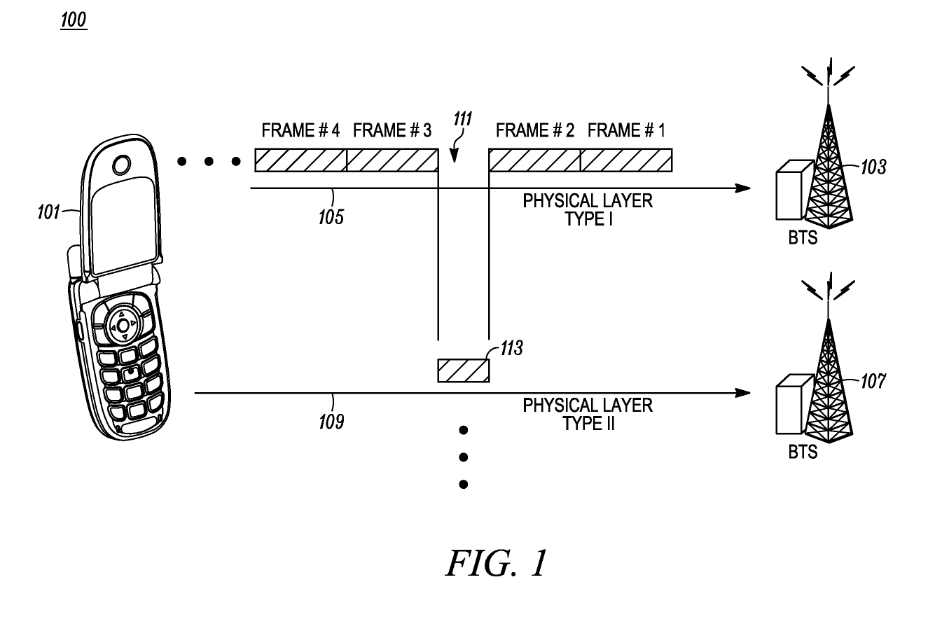

Turning now to the drawings wherein like numerals represent like components, FIG. 1 illustrates a network 100 having various radio access technologies wherein the mobile station 101 may communicate with, and handover between, the various technologies. Therefore the mobile station 101 has various physical layer capabilities. The network comprises various base stations such as base station 103 and base station 107, that may or may not be of the same radio technology. The network 100 comprises other elements not shown, such as, but not limited to, base station controllers, mobile switching centers, etc. Further, functionality of the base stations may be integrated with the base station controller, or various functions may be distributed.

In FIG. 1, mobile station 101 communicates with base station 103 using a physical layer of type 1 105, and may communicate with base station 107 using a physical layer of type 2 109. Assuming for the moment that base stations 103 and 107 use the same physical layer technology, for example UMTS, a UMTS compressed mode provides a transmission gap 111 between frames such that mobile station 101 may measure various parameters of the radio interface from base station 107 and collect measured data 113 during the gap 111.

In the various embodiments herein disclosed, mobile station 101 may also collect measurement data 113 for a radio interface, physical layer type II 109, that is different from physical layer type I 105, such that handovers between the technologies may be better facilitated.

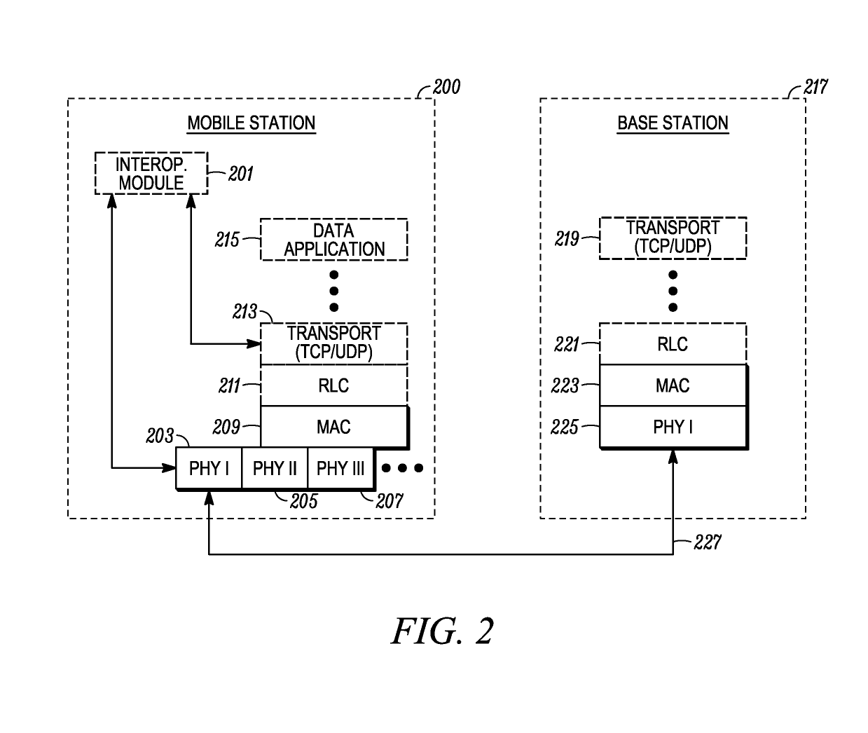

FIG. 2 illustrates a mobile station and base station architecture in accordance with some embodiments. Mobile station 200 comprises a stack having a data application layer 215, a transport control layer 213 using TCP or UDP, a Radio Link Control layer (RLC) 211, a Medium Access Control layer (MAC) 209, and two or more radio technology Physical Layer (PHY) components, such as PHY I 203, PHY II 205 and PHY III 207.

In addition, mobile station 200 has interoperation module 201, which may be separate or may be integrated into any of the other components/layers. The mobile station 200 interoperation module 201 may send and receive messages between the physical layer 203, 205, 207, etc. and the transport layer 213. The mobile station may transmit and receive various messages to and from the base station on the physical layer air interface 227.

The mobile station 201 interoperation module 201 enables the transport control layer 213 to create measurement opportunities for the mobile station in circumstances wherein a handover for one physical layer to another is warranted. The action of the interoperation module 201 is explained in further detail below.

The base station 217, similar to mobile station 200, has an RLC 221, MAC 223 and PHY 225. The modules shown in FIG. 2 may be distributed between a base station and network controller in some embodiments, for example the base station 217 may have a transport layer 219 or the transport layer may be located at a remote server in communication with the base station 217. Various configurations are therefore possible which would remain in accordance with the various embodiments.

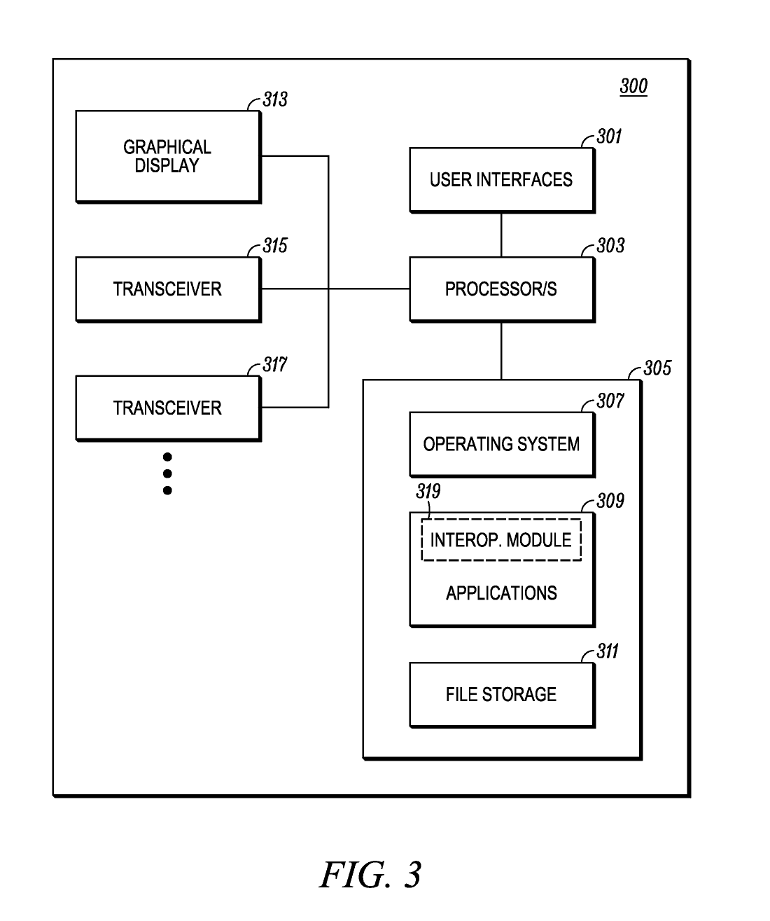

FIG. 3 is a block diagram illustrating the primary components of a mobile station in accordance with some embodiments. Mobile station 300 comprises user interfaces 301, at least one processor 303, and at least one memory 305. Memory 305 has storage sufficient for the mobile station operating system 307, applications 309 and general file storage 311. Mobile station 300 user interfaces 301, may be a combination of user interfaces including but not limited to a keypad, touch screen, voice activated command input, and gyroscopic cursor controls. Mobile station 300 has a graphical display 313, which may also have a dedicated processor and/or memory, drivers etc. which are not shown in FIG. 3.

It is to be understood that FIG. 3 is for illustrative purposes only and is for illustrating the main components of a mobile station in accordance with the present disclosure, and is not intended to be a complete schematic diagram of the various components and connections therebetween required for a mobile station. Therefore, a mobile station may comprise various other components not shown in FIG. 3 and still be within the scope of the present disclosure.

Returning to FIG. 3, the mobile station 300 may also comprise a number of transceivers such as transceivers 315 and 317. Transceivers 315 and 317 may be for communicating with various wireless networks using various standards such as, but not limited to, GSM, UMTS, E-UMTS, E-HRPD, CDMA2000, 802.11, 802.16, etc.

Memory 305 is for illustrative purposes only and may be configured in a variety of ways and still remain within the scope of the present disclosure. For example, memory 305 may be comprised of several elements each coupled to the processor 303. Further, separate processors and memory elements may be dedicated to specific tasks such as rendering graphical images upon a graphical display. In any case, the memory 305 will have at least the functions of providing storage for an operating system 307, applications 309 and general file storage 311 for mobile station 300. In some embodiments, and as shown in FIG. 2, applications 309 may comprise a software stack that communicates with a stack in the base station.

Also in the various embodiments, applications 309 may include an interoperations module 319 for coordinating the transport layer and various physical layer activities.

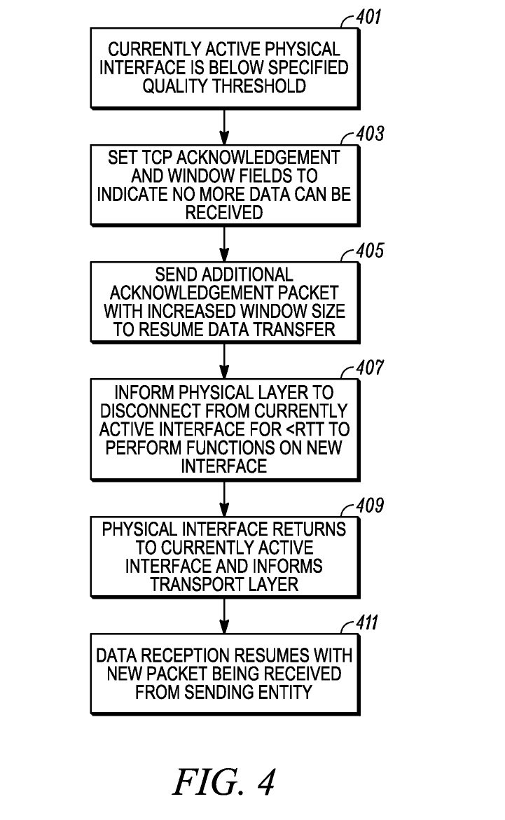

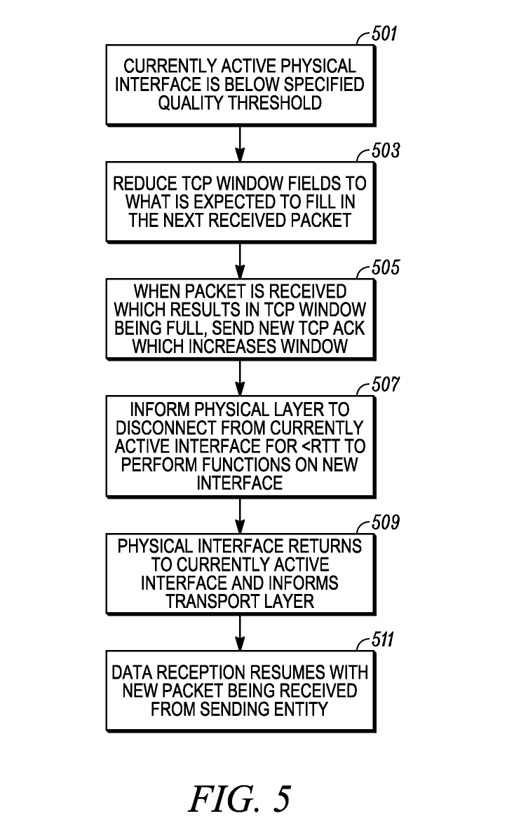

FIG. 4 and FIG. 5 illustrate how opportunities may be created when receive data is not expected on a first physical layer. The transport control protocol layer, TCP, uses the Window Size field in the TCP header to indicate to the sending entity how many unacknowledged bytes of data are allowed to be outstanding.

The receiving entity may implement flow control by setting the Window field and the Acknowledgement field with values that inform the sending entity that no further data should be sent. The transport layer in the mobile station will then inform the physical layer that it is free to disconnect from the currently active physical interface and perform necessary functions such as neighbor measurements, neighbor resource reservation, etc. The transport layer should provide specific timing parameters to the physical layer so that the device will be back on the currently active physical interface before data reception and/or transmission is to resume. The transport layer should consider the calculated Round Trip Time (RTT) of the current transport session to limit the amount of time the device is off the physical channel.

When the type of session is well known, such as a file transfer, the receiving device may use the knowledge that a continual stream of data is expected to set a more deterministic schedule of opportunities, as well as minimizing the time that the data flow is disrupted.

This may be accomplished in some embodiments, by reducing the window size value in acknowledgement packets until the available window size is small enough that the next received packet will fill the window. The receiving device will then know that when this packet is received, no more data is expected until a new acknowledgement packet is sent. In this case, the transport layer informs the physical layer of the opportunity to disconnect from the currently active interface.

Prior to disconnecting the physical interface, the transport layer will send a new acknowledgement packet to open the receiver window again. The transport layer may then provide the physical layer with the idle slot time of something less then RTT, since it knows no more data will arrive until the sender receives the new ACK packet, and sends the new data packet.

The above examples assume that the primary data transfer is from the network to the device. When the primary transfer is from the device to the network, the device may create opportunities as frequently as it needs by delaying the generation of a new data packet. Care should be taken to make sure the physical interface is not disconnected while there is an outstanding ACK packet, since this would result in a lost acknowledgement requiring retransmission, and involvement of TCP congestion mechanisms which would have a detrimental impact on data throughput.

Returning to FIG. 4, the mobile station may determine that a radio interface is below a quality threshold as in 401, and set the TCP acknowledgment window thereby informing the transport layer on the network side ( the transport layer which may be located at a server or the base station depending upon the configuration of the embodiment), that no further data should be sent. In 405 an additional acknowledgment packet with an increased window size to resume data transfer may be sent. Also, the mobile station transport layer may via the interoperation module, inform the physical layer to temporarily disconnect as in 407, so that the second physical layer interface may perform a needed measurement. In 409, the previous physical interface may resume activity, and data reception may resume as in 411.

In FIG. 5, similar to FIG. 4, a threshold is not met in 501, however unlike FIG. 4 in 503 the TCP window is reduced to an expected packet size. In 505, if a packet is received that fills the TCP window, a new TCP acknowledgment message is sent to increase the window. As in 407, in 507 the physical interface may disconnect so that measurements on a different physical interface may be performed. In 509, the physical interface resumes activity and data reception continues in 511.

While various embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method in a mobile station, said mobile station having at least a first and second radio access physical layer and a transport layer, and said mobile station having an active connection on a first radio access physical layer channel with a remote server having a second transport layer, the method comprising:
determining that a criteria corresponding to said first radio access physical layer channel is below a predetermined threshold;
informing said second transport layer of said remote server that no further data will be received by said mobile station over said first radio access physical layer channel;
commanding said first radio access physical layer, based on a feedback message from said transport layer, to disconnect from said first radio access physical layer channel;
disconnecting said first radio access physical layer channel temporarily;
measuring a second radio access physical layer channel;
reconnecting to said first radio access physical layer channel; and
sending a message to said transport layer indicating that said first radio access physical layer channel has been reconnected.

2. The method of claim 1, wherein informing said second transport layer of said remote server that no further data will be received by said mobile station over said first radio access physical layer channel further comprises setting an acknowledgment and window fields.

3. The method of claim 2, further comprising sending an acknowledgement packet with an increase window size to said second transport layer of said remote server to resume data transfer.

4. The method of claim 1, wherein informing said second transport layer of said remote server that no further data will be received by said mobile station over said first radio access physical layer channel further comprises reducing a window field to an expected packet size.

5. The method of claim 4, further comprising sending an acknowledgement packet with an increase window size to said second transport layer of said remote server to resume data transfer if a packet is received large enough to fill said window field.

6. The method of claim 2, wherein said acknowledgment and window fields are Transport Control Protocol acknowledgment and window field.

7. The method of claim 4, wherein said window field is a Transport Control Protocol window field.

8. The method of claim 1, wherein said first physical layer is one of GSM, UMTS, E-UMTS, E-HRPD, CDMA2000, 802.11, or 802.16, and said second physical layer is different than said first physical layer.

9. A mobile station comprising:
at least a first and a second radio transceivers, each transceiver having an associated respective first and second physical layer;
at least one processor coupled to said first and said second radio transceivers; said processor having an interoperation module, said interoperation module coupled to said first and said second physical layers of said first and said second radio transceivers and further coupled to a transport layer, and wherein said processor and said interoperation module are configured to:
detect that said first physical layer has determined that a criteria of a first radio interface corresponding to said first physical layer is below a predetermined threshold;
inform a second transport layer of a remote server coupled to said first physical layer by said first radio interface, that no further data will be received over said first physical layer;
command said first physical layer, based upon feedback information received by said interoperation module from said transport layer, to disconnect from said first radio interface;
disconnect said first radio access physical layer temporarily;
command said second physical layer to measure a second radio interface;
reconnect to said first physical layer channel; and
sending a message to said second transport layer of said remote server indicating that said first radio interface has been reconnected.

10. The mobile station of claim 9, wherein said processor and said interoperation module are further configured to inform said second transport layer of said remote server that no further data will be received by said mobile station over said first radio access physical layer channel further comprises setting an acknowledgment and window fields.

11. The mobile station of claim 10, wherein said processor and said interoperation module are further configured to send an acknowledgement packet with an increase window size to said second transport layer of said remote server to resume data transfer.

12. The mobile station of claim 9, wherein said processor and said interoperation module are further configured to inform said second transport layer of said remote server that no further data will be received by said mobile station over said first radio access physical layer channel by reducing a window field to an expected packet size.

13. The mobile station of claim 12, wherein said processor and said interoperation module are further configured to send an acknowledgement packet with an increase window size to said second transport layer of said remote server to resume data transfer if a packet is received large enough to fill said window field.

14. The mobile station of claim 10, wherein said acknowledgment and window fields are Transport Control Protocol acknowledgment and window fields.

15. The mobile station of claim 12, wherein said window field is a Transport Control Protocol window field.

16. The mobile station of claim 9, wherein said first physical layer is one of GSM, UMTS, E-UMTS, E-HRPD, CDMA2000, 802.11, or 802.16, and said second physical layer is different than said first physical layer.
